(19) United States
(12) Patent Application Publication
(10) Pub. No.: US 2009/0327982 A1
(43) Pub. Date: Dec. 31, 2009

(54) Method of verifying layout data for semiconductor device

(75) Inventors: Yoshihisa Komura, Kasugai (JP); Junji Tomida, Kasugai (JP)

Correspondence Address: STAAS & HALSEY LLP, SUITE 700, 1201 NEW YORK AVENUE, N.W., WASHINGTON, DC, 20005, US

(73) Assignee: FUJITSU MICROELECTRONICS LIMITED, Tokyo (JP)

(21) Appl. No.: 12/457,056

(22) Filed: May 29, 2009

(30) Foreign Application Priority Data
Jun. 26, 2008 (JP) 2008-167703

(51) Int. Cl. G06F 17/50

(52) U.S. Cl. 716/5

(57) ABSTRACT

A data verification method executed by a data verification device that verifies hierarchical structure layout data for a semiconductor device. The method includes retrieving a verification condition that is set in accordance with a data processing system which processes the layout data generated by and provided from a designing device, extracting shaped item existing range information and possessive layout information from the layout data to generate a hierarchical expansion table, cumulating the possessive layout information associated with each cell from an uppermost layer cell of a layout path to a target cell, calculating a cumulative value of the possessive layout information for the layout path, determining whether or not the possessive layout information satisfies the verification condition based on the cumulative value, the verification condition, and the possessive layout information, and determining whether or not the shaped item existing range information satisfies the verification condition.

### CROSS-REFERENCE TO RELATED APPLICATIONS

This application is based upon and claims the benefit of priority from prior Japanese Patent Application No. 2008-167703, filed on Jun. 26, 2008, the entire contents of which are incorporated herein by reference.

### FIELD

The embodiment discussed herein is related to a method of verifying layout data for a semiconductor device.

### BACKGROUND

A designer of a semiconductor device normally performs logic and circuit design with a designing device such as a Computer Aided Design (CAD) device so as to satisfy specifications (mount function and operational speed) corresponding to the application for the semiconductor device. Based on the designed logic circuitry, the designing device generates layout data for the semiconductor device including elements. A data processing device converts the layout data for the semiconductor device generated with the designing device into exposure data, which may be input to a drawing device, which performs drawing on a mask, a reticle, and a wafer. The mask, reticle, and wafer generated in accordance with the exposure data are used to manufacture a semiconductor device chip.

The layout data may have a hierarchical structure. In each hierarchy, each cell includes at least either shaped item data or reference information. The shaped item data contains layout information of the shaped item. If a shaped item is a polygon, the shaped item data may also contain vertex (corner) coordinates of the polygon. If a shaped item includes a linear part, the shaped item data may further contain coordinates of the end points of a line segment corresponding to the linear part and the width of the line segment. The layout information of the shaped item is expressed in a coordinate system defined for each cell and represents the position of each shaped item in the cell. For instance, the position of each shaped item is expressed as a relative position (relative coordinates) with respect to a reference position of the cell. The reference information of each cell is used as layout information of a lower order cell (referenced cell) referred to from that cell, and the layout information is expressed in a coordinate system of a higher order cell.

The data processing device performs an expansion process on the layout data and expresses all of the shaped item data contained in the layout data with the same coordinate system. In the data processing device, all of the shaped item data contained in the developed layout data undergoes performs verification of whether or not a physical interference occurs and verification of whether or not there is correspondence with a netlist. Refer to, for example, Japanese Laid-Open Patent Publication No. 5-94494, Japanese Laid-Open Patent Publication No. 5-303611, and Japanese Laid-Open Patent Publication No. 2000-194743. The data processing device converts the layout data, which was verified as not including any problems, into the exposure data.

Nowadays, in the semiconductor industry, miniaturization in processing technology has raised equipment cost (foundry cost). To lower costs, some makers have stopped fabricating semiconductor devices and specialize in designing semiconductor devices. Other makers specialize in fabricating semiconductor devices. A maker that outsources the fabrication of its products to an outside manufacturer is referred to as a fabless maker. A maker that specializes in the fabrication of products is referred to as a fab maker. A fabless maker often compares and reviews the cost and reliability of a plurality of fab makers and selects the fab maker that provides the best cost performance to suppress production costs.

In a fabless maker (including makers that outsource some of the production fabrication processes to an outside company), a designer generates layout data for a semiconductor device using an Electronic Design Automation (EDA) tool such as a Computer Aided Design (CAD) device. Then, the designer sends the layout data to a fab maker. The fab maker converts the received layout data to mask fabrication data or direct drawing data. Then, the fab maker fabricates semiconductor devices based on the converted data and provides the semiconductor devices to the fabless maker.

A designing device, which generates layout data, and a data processing device, which processes the layout data, may differ in operational environments and system configuration. Such a difference would cause errors when the data processing device of the fab maker processes the layout data generated by the designing device of the fabless maker. The position of each cell contained in the layout data is specified using the reference information of a higher order cell, as described above. Thus, the position of a shaped item contained in the lower order cell is specified by coordinate values with respect to the entire chip by taking into consideration the reference information contained in the cell of each hierarchy forming a path from the highest-order cell to the lower order cell. Even if the numerical values of the reference information contained in each cell is within a range of numerical values processable by the data processing device, for example, within the range of a sign-added maximum integral value and minimum integral value processable by the data processing system, the final coordinate values obtained through calculations may be excluded from the range.

For example, with reference to FIG. 8, an origin O1 and layout information 1 (X coordinate and Y coordinate) contained in a top hierarchy cell determine a reference point O2 in a first lower order hierarchy cell. Layout information 2 contained in the cell is added to the coordinates of the reference point O2 (layout information 1) to determine a reference point O3 in a second lower order hierarchy cell. Furthermore, layout information 3 contained in the cell is added to the coordinates of the reference point O3 (i.e., layout information 1+layout information 2) to determine a reference point O4 in a third lower order hierarchy cell. In the illustrated example, the coordinate value of the reference point O3 is outside the numerical value range (+mx to −mx, +ny to −ny) that is based on the sign-added maximum and minimum integral values processable by the data processing system.

When the cell contained in the data processed by the designing device does not have the shaped item data, some layout devices may allow the layout of the cell without recognizing the exclusion of the reference point O3 from the range illustrated in FIG. 8 as an error. However, some data processing devices do not allow layouts of coordinate values outside the range even if the reference point O3 does not have the shaped item data. Such data processing devices cause an overflow when the calculated coordinate values are outside the range and are changed to abnormal values set for the data processing device. If the fab maker continues fabrication without noticing such situation, masks and semiconductor devices having errors are produced. This may inflict significant damages on the fab maker.

The shaped item does not exist at the reference point O3 in the layout data including the cell having layout information as illustrated in FIG. 8. Thus, a problem such as the reference point O3 is not able to be found by visually checking a layout diagram. Furthermore, such problem may arise or may not arise if the foundry (fab maker) uses a plurality of data processing devices of different system configurations (different computers, different tools, etc.). In other words, the above problem may arise when the fabrication is performed using one data processing device but may not arise when using another data processing device. Thus, the above problem is difficult to find, the analysis of the cause is difficult, and damages may increase.

### SUMMARY

One aspect of the embodiments is a data verification method executed by a data verification device that verifies hierarchical structure layout data for a semiconductor device. The data verification method includes retrieving a verification condition that is set in accordance with a data processing system which processes the layout data generated by and provided from a designing device; extracting shaped item existing range information and possessive layout information from the layout data to generate a hierarchical expansion table and store the table in a storage unit, in which the shaped item existing range information represents a range in which a shaped item exists in cells that are included in the layout data, the possessive layout information is for referring from a cell to a cell that is at least one order lower in hierarchy, and the hierarchical expansion table associates at least either one of the shaped item existing range information and the possessive layout information with each cell; determining a target cell and a layout path to the target cell and storing information of the determined layout path in the storage unit; reading out the possessive layout information associated with the cell of each hierarchy forming the determined layout path from the hierarchical expansion table, cumulating the possessive layout information associated with each cell from an uppermost layer cell of the layout path to the target cell, and calculating a cumulative value of the possessive layout information for the layout path; determining whether or not the possessive layout information satisfies the verification condition based on the cumulative value, the verification condition, and the possessive layout information; and determining whether or not the shaped item existing range information satisfies the verification condition based on the cumulative value of the possessive layout information for the layout path, the shaped item existing range information associated with the target cell, and the verification condition.

Additional objects and advantages of the invention will be set forth in part in the description which follows, and in part will be obvious from the description, or may be learned by practice of the invention. The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF DRAWINGS

The invention, together with objects and advantages thereof, may best be understood by reference to the following description of the presently preferred embodiments together with the accompanying drawings in which:

FIG. 1 is a schematic diagram of a semiconductor device designing system;

FIG. 2 is a schematic diagram of a data verification device;

FIG. 3 is a flowchart of a detailed verification process;

FIG. 4 is a flowchart of a simple verification process;

FIG. 5 is a diagram illustrating hierarchical structure layout data;

FIG. 6 is a hierarchical expansion table;

FIG. 7 is a schematic diagram of a modified data verification device; and

FIG. 8 is a diagram illustrating the determination of the location of a cell using layout information.

### DESCRIPTION OF EMBODIMENTS

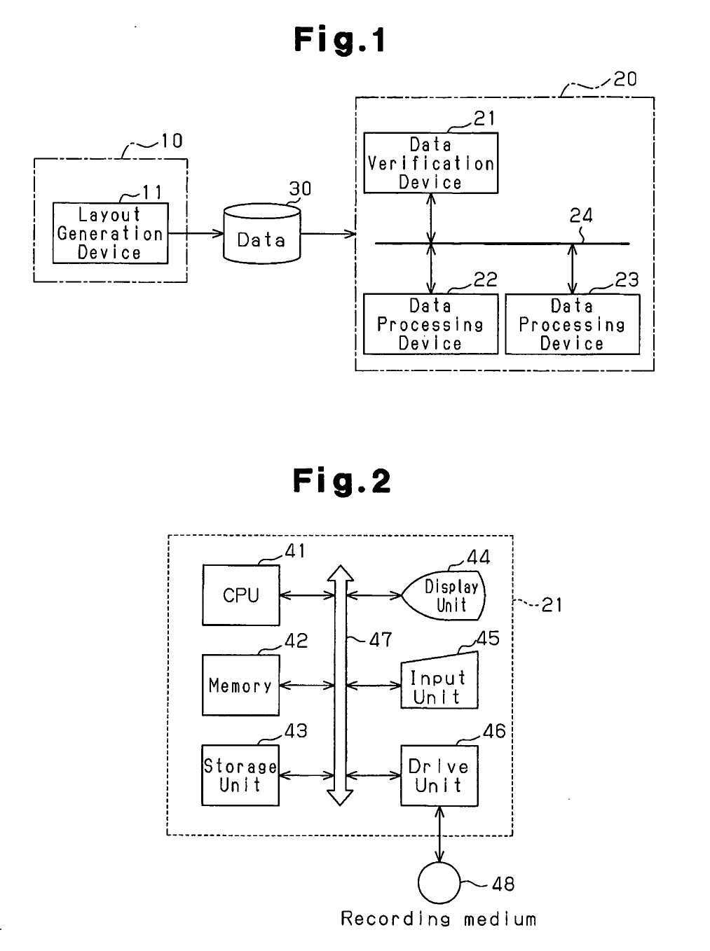

An embodiment will now be described with reference to FIGS. 1 to 7.

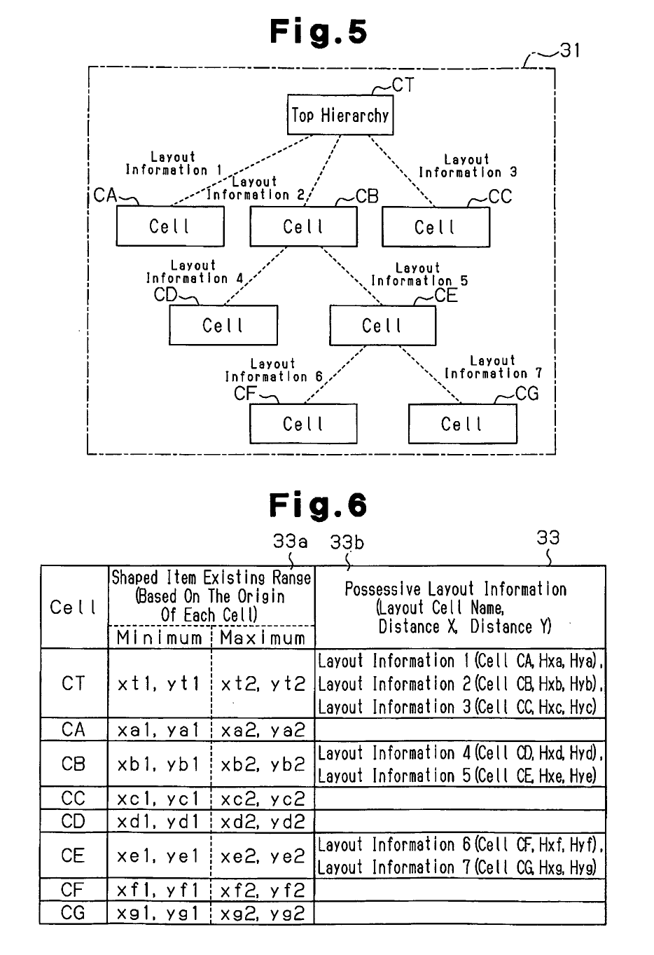

As illustrated in FIG. 1, a fabless maker 10 has a layout generation device 11 serving as a designing device. The fabless maker 10 is, for example, a maker or department that outsources the fabrication of semiconductor devices to an outside manufacturer. The layout generation device 11 has EDA tools for performing function design, logic synthesis, layout design, and the like. The layout generation device 11 generates data 30 necessary for fabricating semiconductor devices using the tools, the data for provision to a vendor, and the data provided from a fab maker 20. The data 30 contains layout data 31 (see FIG. 5) and cell definition data that may be referred to from the layout data 31. The data 30 is sent from the fabless maker 10 to the fab maker 20 through a communication network or recording medium.

The fab maker 20 is, for example, an IC manufacturer (foundry) or a plant (fabricating lab). The fab maker 20 fabricates semiconductor devices based on the data 30 received from the fabless maker 10 and delivers the semiconductor devices to the fabless maker 10.

The fab maker 20 has a data verification device 21 and a data processing system (data processing devices 22 and 23). The devices 21 to 23 are connected to one another through a network 24. The data verification device 21 verifies the layout data 31 contained in the data 30 provided from the fabless maker 10 based on a predetermined verification range value. The data verification device 21 provides the data 30, in which an error was not found in the verification, to the data processing device 22 or 23.

The data processing devices 22 and 23 differ from each other in system configuration. The data processing devices 22 and 23 convert the layout data 31 verified by the data verification device 21 into fabrication data (e.g., reticle drawing data) that is in accordance with the fabrication process. The fab maker 20 fabricates semiconductor devices based on the fabrication data that has been converted. The fab maker 20 delivers the semiconductor devices to the fabless maker 10.

The data verification device 21 will now be described with reference to FIG. 2. The data verification device 21, which is a typical Computer Aided Design (CAD) device, includes a central processing unit (CPU) 41, a main storage unit (memory) 42, a storage unit 43, a display unit 44, an input unit 45, and a drive unit 46, which are connected to one another by a bus 47.

The CPU 41 executes a program using the memory 42 and performs processes required for the verification of the layout data 31. The memory 42 stores programs and data required for the verification processing of the layout data 31. The memory 42 is normally a cache memory, system memory, display memory or graphic memory.

The display unit 44 is used to display the verification result and a verification condition input screen or the like. A CRT (Cathode Ray Tube), LCD (Liquid Crystal Display), PDP (Plasma Display Panel), or the like is normally used as the display unit 44. The input unit 45 is used by the user to input requests, instructions and verification conditions. A keyboard, mouse, and the like are used as the input unit 45.

The storage unit 43 is normally a magnetic disc unit, optical disc unit, magneto-optical disc unit, semiconductor disc device (SSD: Solid State Drive), or the like. The storage unit 43 stores program data (hereinafter referred to as programs) and various types of data files (hereinafter referred to as files) for verifying the layout data 31. The CPU 41 transfers the programs and the data stored in the files to the memory 42 in response to the instruction from the input unit 45 for execution. The storage unit 43 is also used as a database.

The programs executed by the CPU 41 and the layout data 31 are provided by a recording medium 48. The drive unit 46 reads out the programs from the recording medium 48 and installs the programs in the storage unit 43.

The recording medium 48 may be any computer readable recording medium such as memory card, flexible disc, optical disc (CD-ROM, DVD-ROM, . . . ), and magneto-optical disc (MO, MD, . . . ). The above-described programs may be stored in the recording medium 48 and loaded to the memory 42 for use when necessary. The recording medium 48, which only needs to provide the program files and data files, and may be a recording medium inserted into the storage unit or the drive unit of another computer, server, or the like connected by a network.

As described above, the data 30 illustrated in FIG. 1 contains the layout data 31 illustrated in FIG. 5. The layout data 31 includes data for a plurality of cells CT, CA to CG. Each of cells CT to CG has coordinate information based on the origin of each cell. For instance, in the case of a cell of which shaped item is defined, the cell has coordinate information indicating the shape of the shaped item. When checking the coordinate information of the shaped item, the maximum value and the minimum value of the coordinates indicating a shaped item existing range, which is based on the origin of the cell, are extracted. The coordinate information indicating the shape of the shaped item contains the vertex coordinates of a polygon and the layout position of the polygon. Alternatively, the coordinate information includes the coordinates of two end points and the width information of a line segment and the layout position of the line segment. The maximum value and the minimum value of the coordinates are each described in an orthogonal coordinate system (X coordinate and Y coordinate).

The layout data 31 is described in a hierarchical structure. Each of the cells CT to CG contained in the layout data 31 has reference information corresponding to its hierarchical position. The reference information of each cell is the layout position of the lower order cell (referenced cell) to be referred to from the cell. The layout position is expressed in the coordinate system of a higher order cell. In other words, the layout position is expressed by relative coordinate values of a reference position of a referenced cell using the origin of the higher order cell that refers to the cell as a reference. In the case of the layout data 31 illustrated in FIG. 5, the cell CT at the top hierarchy includes the layout information 1 of the cell CA, the layout information 2 of the cell CB, and the layout information 3 of the cell CC as reference information for the lower order hierarchy cell. The cell CB includes the layout information 4 of the cell CD and the layout information 5 of the cell CE as reference information for the lower order hierarchy cell. The cell CE includes the layout information 6 of the cell CF and the layout information 7 of the cell CG as reference information for the lower order hierarchy cell.

The layout data verification process executed by the data verification device 21 will now be discussed.

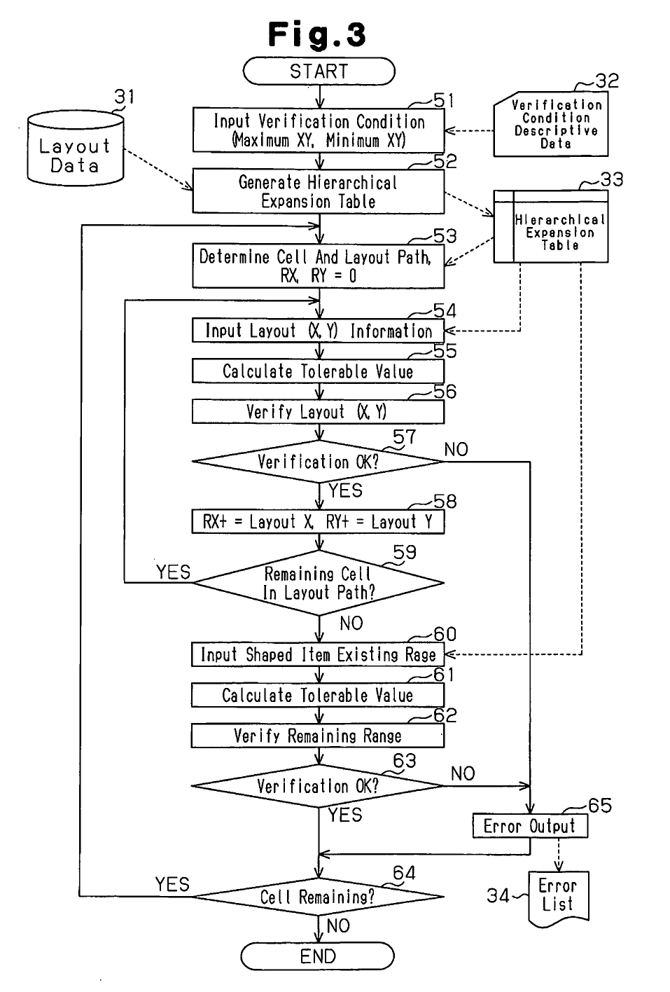

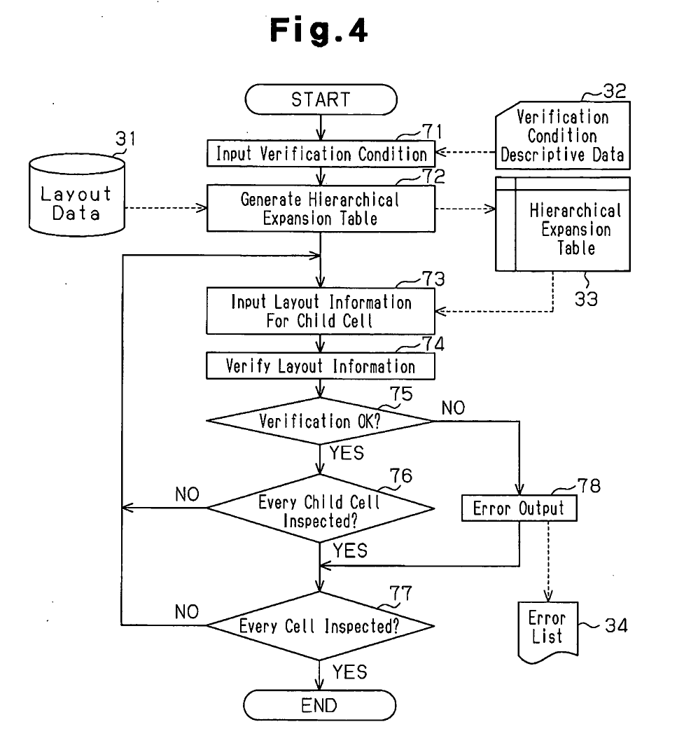

The CPU 41 of the data verification device 21 executes the program for data verification in response to a signal input from the input unit 45 in correspondence with the operation of the operator. The data verification program includes the program of a detailed verification process illustrated in FIG. 3 and a program of a simple verification process illustrated in FIG. 4. The CPU 41 determines whether the operation mode is a detailed verification mode (first mode) or a simple verification mode (second mode) in accordance with the signal input from the input unit 45 corresponding to the operation (e.g., menu selection) of the operator, the mode selection information stored in the storage unit 43, and the like. Then, the CPU 41 executes the program corresponding to the determination result to perform the verification process.

The detailed verification process in the detailed verification mode will be described first according to FIG. 3.

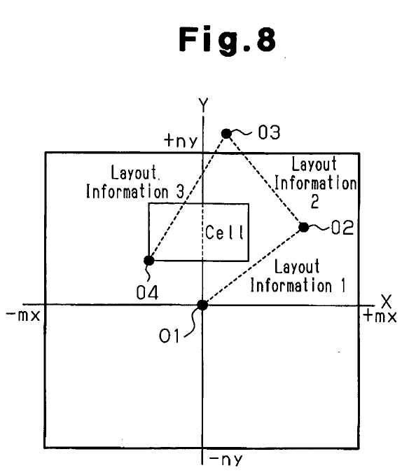

The CPU 41 retrieves verification conditions from verification condition descriptive data 32 (step 51). The verification condition is a condition that does not depend on a numerical value range processable by the layout generation device 11 and the data processing devices 22 and 23 illustrated in FIG. 1. The numerical value range processable by the data processing devices 22 and 23 is a numerical value range (maximum value, minimum value) processable by its system configuration (CPU) or a numerical value range (maximum value, minimum value) allowed in the data processing program executed in the data processing devices 22 and 23. For example, the verification condition stored in the verification condition descriptive data 32 are a signed maximum integral value and minimum integral value (hereinafter sometimes referred to as maximum and minimum integral values), which are expressible by a predetermined number of bits (e.g., 32 bits). FIG. 8 illustrates coordinate values of the maximum and minimum integral values for each of the X-axis and the Y-axis as viewed from the reference point O1 (coordinate value (0,0)) as the maximum and minimum integral values. Among the coordinate values of the maximum and minimum integral values, the coordinate value at the positive side of the reference point (origin) O1 is the maximum value (maximum X,maximum Y), and the coordinate value at the negative side of the reference point O1 is the minimum value (minimum X,minimum Y). For instance, +mx, which is the maximum value for the X-axis, is an example of a maximum integer; +ny, which is the maximum value for the Y-axis, is an example of a maximum integer; −mx, which is the minimum value for the X-axis, is an example of a minimum integer; and −ny, which is the minimum value for the Y-axis, is an example of a minimum integer. The CPU 41 retrieves the verification condition (in particular, verification range values (+mx,−mx,+ny,−ny)).

The CPU 41 then generates a hierarchical expansion table 33 based on the layout data 31 and stores the hierarchical expansion table 33 in the memory 42 illustrated in FIG. 2 (step 52). As illustrated in FIG. 6, the hierarchical expansion table 33 stores shaped item existing range information 33a and possessive layout information 33b in association with the cell. The shaped item existing range information 33a of each cell is the minimum value and the maximum value of each X-axis and Y-axis indicating the existing range of the shaped item of the cell in which the origin of the cell is used as the reference. The possessive layout information 33b of each cell includes a layout cell name or a name of a reference cell referred to from the cell. The possessive layout information 33b of each cell also includes a distance (distance X) in the X-axis direction and a distance (distance Y) in the Y-axis direction from the origin of the cell to the reference point of the layout cell. The CPU 41 extracts the shaped item existing range information and the possessive layout information of each cell for each cell contained in the layout data 31. Then, the CPU 41 stores the same in the hierarchical expansion table 33.

Next, the CPU 41 refers to the hierarchical expansion table 33, determines the cell (target cell) of which shaped item is to be verified and the one of the layout paths including the target cell for which layout information is to be verified, and initializes cumulative coordinate values RX and RY of each axis to zero (step 53). One example of a process for determining the target cell and the layout path will be described.

The CPU 41 proceeds from the top hierarchy cell to the lower layer cell, which is referred to from the top hierarchy cell by the layout information, in accordance with the hierarchical structure of the layout data 31, proceeds from the lower layer cell to a further lower layer cell, which is referred to from the lower layer cell by the layout information, and repeats this to sequentially reach the cells coupled by the layout information. When returning from a certain cell to the cell of a higher-order hierarchy, the coupling of the layout information from the top hierarchy cell to the cell at which the returning occurred is determined as being a single layout path. This will now be described in detail with reference to FIG. 5.

In FIG. 5, the top hierarchy cell CT includes three pieces of possessive layout information (layout information 1, 2, and 3). The CPU 41 first selects one of the three possessive layout information (e.g., layout information 1) for the cell CT. Since the cell CA is laid out in the selected layout information 1, the CPU 41 finds the layout information route from the cell CT to the cell CA. The cell CA does not have possessive layout information, that is, the cell CA does not have a child cell. In this case, the CPU 41 returns from the cell CA to the upper layer, that is, the top cell CT. The CPU 41 determines that a single layout path is formed from the top hierarchy cell CT to the cell CA. The CPU 41 uses the cell CA from which it returned, that is, the lowermost layer cell in the layout path, as the target cell.

In the same manner, the CPU 41 selects one of the possessive layout information (e.g., layout information 2) for the cell CT. Since the cell CB is laid out in the selected layout information 2, the CPU 41 finds the layout information route from the cell CT to the cell CB. The cell CB includes two pieces of possessive layout information (layout information 4 and 5). That is, the cell CB has two child cells. The CPU 41 selects one of the possessive layout information (e.g., layout information 4) and finds the layout information route from the cell CB to the cell CD since the cell CD is laid out in the selected layout information 4. Since the cell CD does not have a child cell, the CPU 41 returns from the cell CD to the upper layer cell CB. The CPU 41 determines that the top hierarchy cell CT to the cell CD, from which the CPU 41 returned, that is, “cell CT”-“cell CB”-“cell CD”, form a single layout path. The CPU 41 uses the cell CD from which it returned as the target cell.

Next, the CPU 41 finds the layout information route to the cell CE in accordance with the layout information 5 for the cell CB. The cell CE includes two pieces of possessive layout information (layout information 6 and 7). That is, the cell CE has two child cells. The CPU 41 selects one of the possessive layout information (e.g., layout information 6) and finds the layout information route to the cell CF in the selected layout information 6. Since the cell CF does not have a child cell, the CPU 41 returns from the cell CF to the upper layer cell CE. The CPU 41 determines that the top hierarchy cell CT to the cell CF, from which the CPU 41 returned, that is, “cell CT”-“cell CB”-“cell CE”-“cell CF”, form a single layout path. The CPU 41 uses the cell CF from which it returned as the target cell.

In the same manner, the CPU 41 finds the layout information route to the cell CG and determines that the top cell CT to the cell CG, from which the CPU 41 returned, that is, “cell CT”-“cell CB”-“cell CE”-“cell CG” form a layout path. The CPU 41 uses the cell CG from which it returned as the target cell.

Since the layout paths are determined for all the child cells CF and CG of the cell CE, the CPU 41 returns from the cell CE to the cell CB. Accordingly, the CPU 41 determines that the top cell CT to the cell CE, from which the CPU 41 returned, that is, “cell CT”-“cell CB”-“cell CE”, form a single layout path. The CPU 41 uses the cell CE from which it returned as the target cell.

In this manner, the CPU 41 determines the layout path for all the cells in the lower layers of the top hierarchy cell CT and determines all the cells as target cells, which are the targets that undergo verification of the shaped item existing range information.

The CPU 41 verifies whether or not the possessive layout information for each cell forming the determined layout path satisfies the verification condition (steps 54 to 59). As described above, if the maximum and minimum integral values are set as the verification condition, the CPU 41 determines whether or not the reference point of the cell that is laid out by the possessive layout information of the layout data 31 is within the range of the maximum and minimum integral values. More specifically, the CPU 41 determines whether or not the coordinate value of the X-axis of the reference point is a value between the maximum value (+mx) and the minimum value (−mx) of the X-axis and also determines whether or not the coordinate value of the Y-axis of the reference point is a value between the maximum value (+ny) and the minimum value (−ny) of the Y-axis.

Specifically, the CPU 41 retrieves the possessive layout information associated with the determined layout path from the hierarchical expansion table 33 of the possessive layout information 33b, which corresponds to the cell CT of the highest order, that is, the top hierarchy in the determined layout path (step 54). For example, if the determined layout path is “cell CT”-“cell CB”-“cell CD”, the CPU 41 retrieves the possessive layout information associated with the cell CB, that is, the layout information 2 of the possessive layout information 33b associated with the top hierarchy cell CT.

The CPU 41 then calculates an addition or subtraction tolerable value based on the verification condition retrieved in step 51, the layout information 2 retrieved in step 54, and the cumulative coordinate values RX and RY for each axis (step 55). The tolerable value is the difference between the maximum value and minimum value, which is the verification condition, from the reference point of the retrieved layout information 2. The difference is a value tin which the result of the adding to or subtracting from the reference point does not exceed the maximum value and the minimum value of the maximum and minimum integral values.

The CPU 41 calculates the difference between the corresponding maximum value or minimum value and the cumulative coordinate values RX and RY in accordance with the sign of the cumulative coordinate values RX and RY and sets the difference value as the tolerable value. If the cumulative coordinate value RX is a positive value having a positive sign in FIG. 6, the addable maximum value to be determined is obtained. In this case, the CPU 41 calculates a tolerable value AX for the X-axis with the following equation based on the maximum value (+mx) and the cumulative coordinate value RX.

AX=+mx−RX

If the cumulative coordinate value RX is a negative value having a negative sign, the addable minimum value (negative value) that is to be determined is obtained. In this case, the CPU 41 calculates the tolerable value AX for the X-axis using the following equation based on the minimum value (−mx) and the cumulative coordinate value RX.

AX=−m−RX

In the same manner for the Y-axis, the CPU 41 calculates a tolerable value AY for the Y-axis based on the maximum value (+ny) or the minimum value (−ny) and the cumulative coordinate value RY.

AY=+ny−RY or

AY=−ny−RY

The CPU 41 then compares the tolerable values AX and AY and coordinate values Hxb and Hyb of the possessive layout information 33b to verify the coordinate values Hxb and Hyb (step 56). Specifically, the CPU 41 determines whether or not the coordinate values Hxb and Hyb are normal based on the comparison result of the tolerable values AX and AY and the coordinate values Hxb and Hyb, and the signs (positive or negative) of the cumulative coordinate values RX and RY.

For instance, if the cumulative coordinate value RX is a positive value and the coordinate value Hxb is smaller than the tolerable value AX, the CPU 41 determines that the coordinate value Hxb is normal. If the cumulative coordinate value RX is a positive value and the coordinate value Hxb is larger than the tolerable value AX, the CPU 41 determines that the coordinate value Hxb is over the verification value and exceeds the tolerable value AX. Thus, the coordinate value is abnormal.

If the cumulative coordinate value RX is a negative value and the coordinate value Hxb is larger than the tolerable value AX, the CPU 41 determines that the coordinate value Hxb is normal. If the cumulative coordinate value RX is a negative value and the coordinate value Hxb is smaller than the tolerable value AX, the CPU 41 determines that the coordinate value Hxb is under the verification value and exceeds the tolerable value AX. Thus, the coordinate value Hbx is abnormal.

If the cumulative coordinate value RY is a positive value and the coordinate value Hyb is smaller than the tolerable value AY, the CPU 41 determines that the coordinate value Hyb is normal. If the cumulative coordinate value RY is a positive value and the coordinate value Hyb is larger than the tolerable value AY, the CPU 41 determines that the coordinate value Hyb is over the verification value and exceeds the tolerable value AY. Thus, the coordinate value Hyb is abnormal.

If the cumulative coordinate value RY is a negative value and the coordinate value Hyb is larger than the tolerable value AY, the CPU 41 determines that the coordinate value Hyb is normal. If the cumulative coordinate value RY is a negative value and the coordinate value Hyb is smaller than the tolerable value AY, the CPU 41 determines that the coordinate value Hyb is under the verification value and exceeds the tolerable value AY. Thus, the coordinate value Hyb is abnormal.

The CPU 41 then determines whether or not the verification is OK (step 57). If the coordinate value Hxb and the coordinate value Hyb are both normal in step 56, the CPU 41 determines that verification is OK, that is, the reference point of the cell CB laid out by the layout information 2 is within the verification range, and the reference point exists within the maximum and minimum integral values. In this case, the CPU 41 proceeds to the next step 58. The CPU 41 adds the coordinate values Hxb and Hyb to the cumulative coordinate values RX and RY, respectively (step 58). In other words, the following expressions are obtained.

RX+=Hxb

RY+=Hyb

This addition result is the coordinate value of the reference point of the cell CB.

The CPU 41 then determines whether or not there is remaining cell in the layout path (step 59). The CPU 41 determines whether or not a cell other than the top hierarchy cell CT of which possessive layout information has not been verified exists in the layout path determined in step 53. The CPU 41 proceeds to step 54 if a non-verified cell exists and proceeds to the next step 60 if a non-verified cell does not exist.

For example, in the possessive layout information of the cell CB contained in the layout path determined in step 53, the possessive layout information (layout information 4) referred to from the cell CD remains non-verified. In this case, the CPU 41 proceeds from step 59 to step 54. The CPU 41 then reads out the possessive layout information 33b (coordinate values Hxd and Hyd) of the cell CB from the hierarchical expansion table 33 (step 54) and calculates the addition or subtraction tolerable values AX,AY (step 55). The CPU 41 then compares the tolerable values AX and AY and the coordinate values Hxd and Hyd to verify the coordinate values Hxd and Hyd (step 56). Next, the CPU 41 determines whether or not the verification is OK (step 57), and adds the coordinate values Hxd,Hyd to the cumulative coordinate values RX,RY, respectively, if verification is OK (step 58). The CPU 41 then determines whether or not there is a remaining cell in the layout path (step 59).

As described above, the CPU 41 repeatedly executes the processes from step 54 to step 59 until there is no longer a cell of which possessive layout information is not verified in the layout path determined in step 53. The CPU 41 sequentially performs processing from the uppermost layer cell in the layout path, that is, the top hierarchy cell CT, towards the lower layers. Therefore, the CPU 41 repeatedly performs the processes to reach the lowermost layer cell in the layout path, that is, the target cell. The CPU 41 repeatedly performs the processing until reaching the target cell to verify the possessive layout information 33b for every one of the cells forming the layout path. If all the possessive layout information in the layout path is normal (YES in step 57), the cumulative coordinate values RX and RY indicate the coordinate value of the reference point of the target cell in the coordinate system of the reference point of the top hierarchy cell CT, that is, the coordinate system of the semiconductor device (chip). Therefore, the CPU 41 verifies the shaped item existing range information in the target cell based on the cumulative coordinate values RX and RY (steps 60 to 63).

First, the CPU 41 retrieves the shaped item existing range information (minimum values xd1,yd1, maximum values xd2,yd2) of the target cell, that is, the cell CD from the hierarchical expansion table 33 (step 60). In the same manner as in step 55, the CPU 41 calculates addition or subtraction tolerable values AX and AY based on the verification condition retrieved in step 51, the shaped item existing range information retrieved in step 60, and the cumulative coordinate values RX and RY of each axis (step 61).

In this case, the cumulative coordinate values RX and RY are respectively the cumulative values for the coordinate values of the layout information 2 and 4 from the highest order cell CT to the cell CD, which is the target cell, in the layout path. This obtains the expressions described below.

RX=Hxb+Hxd

RY=Hyb+Hyd

The CPU 41 then compares the tolerable value AX with the coordinate values xd1 and xd2 in the shaped item existing range information 33a and the tolerable value AY with the coordinate values yd1 and yd2 to verify the shaped item existing range information 33a (step 62). Specifically, the CPU 41 determines whether or not the coordinate values xd1 to yd2 of the shaped item existing range information 33a are normal based on the comparison results of the tolerable values AX and AY with the coordinate values of the shaped item existing range information 33a and the sign (positive or negative) of the cumulative coordinate values RX and RY.

In other words, if the cumulative coordinate value RX is a positive value and the coordinate value xd1 is smaller than the tolerable value AX, the CPU 41 determines that the coordinate value xd1 is normal. If the cumulative coordinate value RX is a positive value and the coordinate value xd1 is larger than the tolerable value AX, the CPU 41 determines that the coordinate value xd1 is over the verification value and exceeds the tolerable value AX. Thus, the coordinate value is abnormal.

If the cumulative coordinate value RX is a negative value and the coordinate value xd1 is larger than the tolerable value AX, the CPU 41 determines that the coordinate value xd1 is normal. If the cumulative coordinate value RX is a negative value and the coordinate value xd1 is smaller than the tolerable value AX, the CPU 41 determines that the coordinate value xd1 is under verification value and exceeds the tolerable value AX. Thus, the coordinate value xd1 is abnormal.

If the cumulative coordinate value RY is a positive value and the coordinate value yd1 is smaller than the tolerable value AY, the CPU 41 determines that the coordinate value yd1 is normal. If the cumulative coordinate value RY is a positive value and the coordinate value yd1 is larger than the tolerable value AY, the CPU 41 determines that the coordinate value yd1 is over the verification value and exceeds the tolerable value AY. Thus, the coordinate value yd1 is abnormal.

If the cumulative coordinate value RY is a negative value and the coordinate value yd1 is larger than the tolerable value AY, the CPU 41 determines that the coordinate value yd1 is normal. If the cumulative coordinate value RY is a negative value and the coordinate value yd1 is smaller than the tolerable value AY, the CPU 41 determines that the coordinate value yd1 is under verification value and exceeds the tolerable value AY. Thus, the coordinate value yd1 and is abnormal.

The CPU 41 also determines normality and abnormality for the maximum coordinate values xd2 and yd2 of the shaped item existing range information 33a in the same manner as in the coordinate values xd1,yd1.

The CPU 41 then determines whether or not verification is OK (step 64). If the coordinate values xd1 to yd2 are all normal in step 62, the CPU 41 determines that verification is OK, that is, the shaped item in the shaped item existing range of the cell CD is within the verification range and exists within the range of the maximum and minimum integral values. Then, the CPU 41 proceeds to the next step 64.

The CPU 41 then determines whether or not there is remaining cell in the layout path (step 64). The CPU 41 determines whether or not a cell other than the top hierarchy cell CT in the layout data 31 has not undergone verification of the shaped item existing range information. The CPU 41 proceeds to step 53 if a non-verified cell exists and determines the next layout path. The CPU 41 terminates the data verification process if a non-verified cell does not exist.

When determined that at least either one of the coordinate value Hxb and the coordinate value Hyb is abnormal in step 56, the CPU 41 determines that the verification is no good (NG), that is, the reference point of the cell CB laid out by the layout information 2 is outside the verification range and the reference point does not exist within the range of the maximum and minimum integral values in step 57. In this case, the CPU 41 proceeds to step 65. When determined that at least one of the coordinate values xd1 to yd2 of the shaped item existing range information 33a is abnormal in step 62, the CPU 41 determines that the verification is NG, that is, part of the shaped item existing range is outside the verification range and does not exist on a chip in step 63. In this case, the CPU 41 proceeds to step 65.

The CPU 41 then performs an error output process (step 65) and outputs an error list 34. The error list 34 is displayed on the display unit 44 in FIG. 2. The error list 34 may be output to an output device such as a printer.

The simple verification process in the simple verification mode will now be described with reference to FIG. 4.

The verification value is not a limit value such as the maximum and minimum integral values but is a realistic numerical value (numerical value corresponding to the target of design and production) such as a chip size.

The verification condition descriptive data 32 stores a chip size as the verification condition. As illustrated in FIG. 8, the chip size is the coordinate values for the X-axis and Y-axis of an end point of a chip when the reference point O1 is the origin (0,0). The coordinate value for the positive side of the reference point O1 is the maximum value (maximum X,maximum Y), and the coordinate value for the negative side of the reference point O1 is the minimum value (minimum X,minimum Y). For example, when setting the reference point O1 at the center of the chip, the chip size is expressed by the maximum value (+mx) of the X-axis, the maximum value (+ny) of the Y-axis, the minimum value (−mx) of the X-axis, and the minimum value (−ny) of the Y-axis. The CPU 41 retrieves the verification condition (range value (+mx,−mx,+ny,−ny) of the chip size).

In the same manner as in step 51 of the detailed verification process, the CPU 41 retrieves the verification condition from the verification condition descriptive data 32 (step 71). The, in the same manner as in step 52 of the detailed verification process, the CPU 41 generates the hierarchical expansion table 33 in the memory 42 illustrated in FIG. 2 based on the layout data 31 (step 72).

Next, the CPU 41 retrieves the layout information of the child cell from the hierarchical expansion table 33 (step 73). The layout information is the position for laying out the child cell defined by the coordinate system of the higher order cell, that is, the position X and Y of the possessive layout information 33b. As illustrated in FIG. 6, the CPU 41 extracts the possessive layout information of the cell contained in the data 31 from the layout data 31 illustrated in FIG. 5 and stores the possessive layout information in the hierarchical expansion table 33. The CPU 41 reads the possessive layout information 33b stored in the hierarchical expansion table 33.

The CPU 41 then performs a layout information test (step 74). In the test, the CPU 41 compares the coordinate values X and Y of the possessive layout information 33b read from the hierarchical expansion table 33 with the X-axis value (−mx,+mx) and Y-axis value (−ny,+ny) of the verification condition. The CPU 41 determines whether the coordinate values X, Y are normal or abnormal based on the comparison result.

Specifically, the CPU 41 determines whether or not the coordinate values X and Y of the possessive layout information 33b are normal based on the comparison result of the verification value and coordinate values of the possessive layout information 33b and the sign (positive or negative) of the coordinate values X and Y.

In other words, when the coordinate value X is a positive value, the CPU 41 determines that the coordinate value X is normal if the coordinate value X is smaller than the verification value (+mx) and determines that the coordinate value X is abnormal if the coordinate value X is larger than the verification value (+mx). When the coordinate value X is a negative value, the CPU 41 determines that the coordinate value X is normal if the coordinate value X is larger than the verification value (−mx) and determines that the coordinate value X is abnormal if the coordinate value X is smaller than the verification value (−mx).

In the same manner, when the coordinate value Y is a positive value, the CPU 41 determines that the coordinate value Y is normal if the coordinate value Y is smaller than the verification value (+ny) and determines that the coordinate value Y is abnormal if the coordinate value Y is larger than the verification value (+ny). When the coordinate value Y is a negative value, the CPU 41 determines that the coordinate value Y is normal if the coordinate value Y is larger than the verification value (−ny) and determines that the coordinate value Y is abnormal if the coordinate value Y is smaller than the verification value (−ny).

Next, the CPU 41 determines whether or not verification is OK (step 75). If the coordinate value X and the coordinate value Y are both normal in step 74, the CPU 41 determines that verification is OK, that is, the layout information is the value within the range processable in the data processing devices 22 and 23 illustrated in FIG. 1 and proceeds to step 76.

Then, the CPU 41 determines whether or not the testing of every one of the child cells has been completed (step 76). The cell (parent cell) that refers to the cell (child cell) in the lower layer uses the possessive layout information as the information for referring to at least one child cell. Accordingly, in step 76, for every one of the child cells referred to from the parent cell, the CPU 41 determines whether or not the determination of whether the possessive layout information for referring to each child cell is normal or abnormal. The CPU 41 proceeds to step 73 if the determination has not been completed for every one of the child cells and proceeds to step 77 if the determination has been completed. In other words, the CPU 41 repeatedly executes the processes of steps 73 to 75 and tests the layout information of every one of the child cells referred to from one cell.

The CPU 41 then determines whether or not the testing has been completed for every one of the cells (step 77). In other words, the CPU 41 determines for every one of the cells having the possessive layout information for referring to the child cell whether or not the testing of the possessive layout information for the cell has been completed. The CPU 41 proceeds to step 73 if an untested cell exists. The CPU 41 terminates the simple verification process may output a verification successful message if an untested cell does not exist.

When determined in step 75 that at least either one of the coordinate value X and the coordinate value Y is abnormal in step 74, the CPU 41 determines that the verification is NG, that is, the coordinate values X and Y of the possessive layout information is not within the range processable by the data processing devices 22 and 23 illustrated in FIG. 1. In this case, the CPU 41 proceeds to step 78. The CPU 41 then performs an error output process (step 78) and outputs the error list 34. The error list 34 is displayed on the display unit 44 in FIG. 2. The error list 34 may be output to an output device such as a printer in the same manner as in step 65.

The present embodiment has the advantages described below.

(1) The data verification device 21 retrieves the verification condition descriptive data 32 that is set in accordance with the data processing system (22, 23) which processes the layout data 31 for a semiconductor device generated by and provided from the layout generation device 11. The data verification device 21 then extracts from the layout data 31 the shaped item existing range information 33a indicating the range of the shaped item in the cell and the possessive layout information 33b for referring to the lower layer cell in the hierarchical structure from the cell, generates the hierarchical expansion table 33 corresponded with at least one of the shaped item existing range information or the possessive layout information for every cell, and stores the table 33 in the storage unit 43. The data verification device 21 then determines the target cell and the layout path to the target cell and stores the information on such layout path in the storage unit 43. The data verification device 21 reads out the possessive layout information 33b associated with the cell of each hierarchy from the hierarchical expansion table 33 in accordance with the layout path and calculates the cumulative coordinate values RX and RY cumulating the possessive layout information associated with the cell of each hierarchy in accordance with the layout path from the uppermost layer cell to the target cell in the layout path. The data verification device 21 determines whether or not the possessive layout information 33b satisfies the verification condition based on the cumulative coordinate values RX and RY, the verification condition, and the possessive layout information 33b.

Accordingly, the possessive layout information 33b extracted from the layout data 31 is cumulated in accordance with the layout path, and whether or not the possessive layout information 33b indicating the child cell referred to from each cell satisfies the verification condition is determined based on the cumulative coordinate values RX and RY and the verification condition. Whether or not the layout data is compatible to the data processing system is then verified without processing the coordinate values of individual shaped item data. By setting the verification condition according to the data processing system, the layout data 31 may be verified as to whether it is applicable to the data processing devices 22 and 23 for processing the layout data 31.

(2) The data verification device 21 determines whether or not the shaped item existing range information 33a satisfies the verification condition based on the cumulative coordinate values RX and RY of the possessive layout information 33b to the target cell in the layout path, the shaped item existing range information 33a of the target cell, and the verification condition. Therefore, the possessive layout information 33b extracted from the layout data 31 is cumulated in accordance with the layout path, and whether or not the shaped item existing range information 33a of the target cell satisfies the verification condition is determined based on the cumulative coordinate values RX, RY and the verification condition. Whether or not the layout data is applicable to the data processing system is then verified without processing the coordinate values of individual shaped item data.

(3) The data verification device 21 calculates the difference between the cumulative coordinate values RX and RY and the verification condition as the tolerable values AX and AY and compares the possessive layout information 33b for the cell of the corresponding hierarchy and the tolerable values AX and AY to determine whether or not the possessive layout information 33b satisfies the verification condition descriptive data 32. Accordingly, even in the data processing device in which an error (overflow) occurs when adding the cumulative coordinate values RX and RY and the possessive layout information 33b, the occurrence of an error due the possessive layout information 33b is checked without performing the addition calculation. In other words, verification of the possessive layout information 33b is ensured within the range processed by the data processing device.

(4) The data verification device 21 calculates the difference from the cumulative coordinate values RX and RY of the possessive layout information 33b to the target cell as the tolerable values AX and AY to compare the shaped item existing range information 33a for the cell of the corresponding hierarchy with the tolerable values AX and AY to determine whether or not the shaped item existing range information 33a of the target cell satisfies the verification condition descriptive data 32. Accordingly, even in a data processing device in which an error (overflow) occurs when adding the cumulative coordinate values RX and RY and the shaped item existing range information 33a, the occurrence of an error due to the possessive layout information 33b is checked without performing the addition calculation. In other words, verification of the possessive layout information 33b is ensured within the range processed by the data processing device.

(5) The data verification device 21 determines whether the present operation mode is the detailed verification mode or the simple verification mode. When the operation mode is the detailed verification mode, the data verification device 21 executes the detailed verification process for comparing the tolerable values AX and AY, which is calculated from the cumulative coordinate values RX and RY of the possessive layout information for each cell in a layout path, with the verification condition descriptive data 32 and the possessive layout information 33b and the shaped item existing range information 33a to verifying both information 33a and 33b. When the operation mode is the simple verification mode, the data verification device 21 executes the simple verification process for comparing the possessive layout information 33b for each cell and the verification condition descriptive data 32 to determine whether or not the possessive layout information 33b satisfies the verification condition descriptive data 32. Therefore, whether or not the possessive layout information and the shaped item existing range information of each cell satisfy the verification condition is verified by setting the operation mode and executing the detailed verification mode. Accordingly, the verification of whether the layout data 31 is within the numerical value range processable by the data processing devices 22 and 23 is performed in a short period of time by setting the operation mode and executing the simple verification mode.

It should be apparent to those skilled in the art that the present invention may be embodied in many other specific forms without departing from the spirit or scope of the invention. Particularly, it should be understood that the present invention may be embodied in the following forms.

In the above-described embodiment, the maximum and minimum integral values and the chip size are set for the verification condition descriptive data 32. However, it is only required that a range that is most likely to include the numerical value (coordinate value) of the layout data 31 be set, and a numerical value and range other than the maximum and minimum integral values and the chip size may be set for the verification condition descriptive data 32. For instance, a numerical range processable in the system or a numerical range that does not depend on the configuration of the system (layout generation device 11, data processing devices 22, 23) may be set for the verification condition descriptive data 32.

In the above-described embodiment, the maximum and minimum integral values and the chip size are set for the verification condition descriptive data 32. However, the verification condition descriptive data 32 may be changed in accordance with the target data processing devices 22 and 23 for processing the layout data 31.

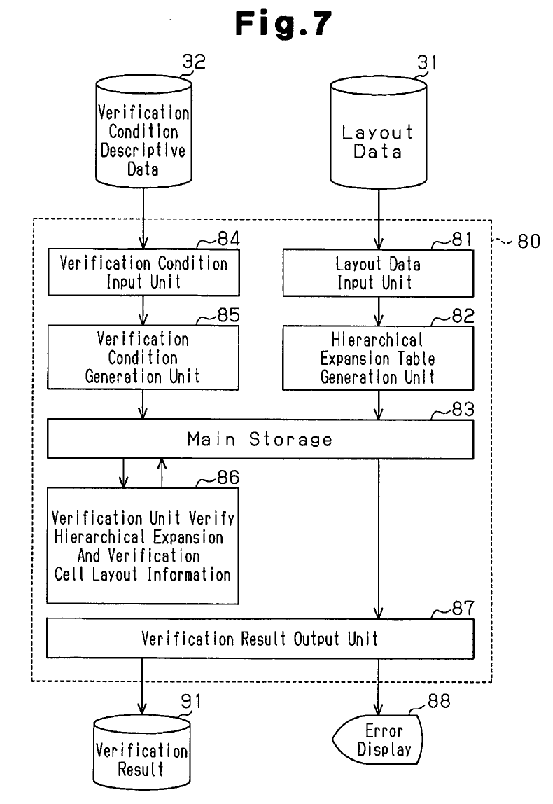

In the above-described embodiment, the data verification device 21 is a typical CAD device. However, the system configuration for the data verification device 21 may be changed as required. For instance, a data verification device 80 illustrated in FIG. 7 includes a layout data input unit 81 for retrieving the layout data 31. A hierarchical expansion table generation unit 82 extracts the layout information of the child cell referred to from a cell and the shaped item existing range information of the cell in accordance with the hierarchical structure of the layout data from the layout data retrieved by the input unit 81 to generate the hierarchical expansion table 33 (see FIG. 6) in a main storage 83. A verification condition input unit 84 retrieves the verification condition descriptive data 32, and a verification condition generation unit 85 stores the verification condition retrieved by the verification condition input unit 84 in an internal table of the main storage 83. In accordance with the mode information stored in the main storage 83, a verification unit 86 executes the processes of step 53 to step 65 illustrated in FIG. 3 in the detailed verification mode and executes the processes of step 73 to step 78 illustrated in FIG. 4 in the simple verification mode. The verification unit 86 stores the verification result in each mode in the main storage 83. A verification result output unit 87 reads out the verification result stored in the main storage 83 to generate a verification result file 91. The verification result output unit 87 also displays the verification result (including any error) on a coupled display unit 88.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention has been described in detail, it should be understood that the various changes, substitutions, and alterations could be made hereto without departing from the spirit and scope of the invention.

What is claimed is:

1. A data verification method executed by a data verification device that verifies hierarchical structure layout data for a semiconductor device, the data verification method comprising:
retrieving a verification condition that is set in accordance with a data processing system which processes the layout data generated by and provided from a designing device;
extracting shaped item existing range information and possessive layout information from the layout data to generate a hierarchical expansion table and store the table in a storage unit, in which the shaped item existing range information represents a range in which a shaped item exists in cells that are included in the layout data, the possessive layout information is for referring from a cell to a cell that is at least one order lower in hierarchy, and the hierarchical expansion table associates at least either one of the shaped item existing range information and the possessive layout information with each cell;
determining a target cell and a layout path to the target cell and storing information of the determined layout path in the storage unit;
reading out the possessive layout information associated with the cell of each hierarchy forming the determined layout path from the hierarchical expansion table, cumulating the possessive layout information associated with each cell from an uppermost layer cell of the layout path to the target cell, and calculating a cumulative value of the possessive layout information for the layout path;
determining whether or not the possessive layout information satisfies the verification condition based on the cumulative value, the verification condition, and the possessive layout information; and
determining whether or not the shaped item existing range information satisfies the verification condition based on the cumulative value of the possessive layout information for the layout path, the shaped item existing range information associated with the target cell, and the verification condition.

2. The data verification method according to claim 1, wherein in the determining whether or not the possessive layout information satisfies the verification condition, the data verification device calculates for each hierarchy a difference between the cumulative value, which is obtained from the uppermost layer cell to the cell of the hierarchy, and the verification condition as a tolerable value, compares the possessive layout information of the cell in the hierarchy with the tolerable value, and determines whether or not the possessive layout information satisfies the verification condition.

3. The data verification method according to claim 1, wherein in the determining whether or not the shaped item existing range information satisfies the verification condition, the data verification device calculates a difference between the cumulative value of the possessive layout information for the layout path and the verification condition as a tolerable value, compares the shaped item existing range information for the cell of each hierarchy with the tolerable value, and determines whether or not the shaped item existing range information of the target cell satisfies the verification condition.

4. The data verification method according to claim 1, wherein the data verification device:
determines an operation mode in accordance with a signal based on operation of an input unit or information stored in the storage unit;
when the operation mode is a first mode, executes a detailed verification process including the retrieving a verification condition set through the determining whether or not the shaped item existing range information; and
when the operation mode is a second mode, executes a simple verification process, the simple verification process including:
retrieving the verification condition that is set in accordance with a data processing system which processes the layout data;
extracting from the layout data the shaped item existing range information, which represents a range in which a shaped item exists in cells, and the possessive layout information, which is for referring from a cell to a cell that is at least one order lower in hierarchy, and storing the hierarchical expansion table, which associates at least either one of the shaped item existing range information and the possessive layout information with each cell, in the storage unit;
reading out from the hierarchical expansion table the possessive layout information associated with a target cell, which is a child cell; and
comparing the read out possessive layout information with the verification condition to determine whether or not the read out possessive layout information satisfies the verification condition.

5. The data verification method according to claim 1, further comprising:
outputting a result of the determining whether or not the shaped item existing range information satisfies the verification condition.

6. The data verification method according to claim 1, wherein the determining whether or not the shaped item existing range information satisfies the verification condition is executed before the layout data is provided to the data processing system, and the method further comprising:
providing the layout data having that satisfies the verification condition to the data processing system.

7. A data verification device that verifies hierarchical structure layout data for a semiconductor device, the data verification device comprising:
an input unit which retrieves a verification condition that is set in accordance with a data processing system which processes the layout data generated by and provided from a designing device;
a verification condition generation unit which stores the verification condition in a storage unit;
a data input unit which retrieves the layout data;
a table generation unit which extracts shaped item existing range information and possessive layout information from the layout data to generate a hierarchical expansion table and store the table in a storage unit, in which the shaped item existing range information represents a range in which a shaped item exists in cells that are included in the layout data, the possessive layout information is for referring from a cell to a cell that is at least one order lower in hierarchy, and the hierarchical expansion table associates at least either one of the shaped item existing range information and the possessive layout information with each cell; and
a verification unit which:
determines a target cell and a layout path to the target cell and stores information of the determined layout path in the storage unit;
reads out the possessive layout information associated with the cell of each hierarchy forming the determined layout path from the hierarchical expansion table, cumulates the possessive layout information associated with each cell from an uppermost layer cell of the layout path to the target cell, and calculates a cumulative value of the possessive layout information for the layout path;
determines whether or not the possessive layout information satisfies the verification condition based on the cumulative value, the verification condition, and the possessive layout information; and
determines whether or not the shaped item existing range information satisfies the verification condition based on the cumulative value of the possessive layout information for the layout path, the shaped item existing range information associated with the target cell, and the verification condition.

8. The data verification device according to claim 7, wherein the verification unit calculates a difference between the cumulative value, which is obtained for each hierarchy, and the verification condition as a tolerable value, compares the possessive layout information of a child cell referred to from the cell in the hierarchy with the tolerable value, and determines whether or not the possessive layout information representing the child cell satisfies the verification condition.

9. The data verification device according to claim 8, wherein the verification unit calculates a difference between the cumulative value of the possessive layout information obtained until reaching the target value and the verification condition as an tolerable value, compares the possessive layout information for the cell of each hierarchy with the tolerable value, and determines whether or not the shaped item existing range information of the target cell satisfies the verification condition.

10. The data verification device according to claim 7, wherein the verification unit:
determines an operation mode in accordance with a signal based on operation of an input unit or information stored in the storage unit;
executes a detailed verification process when the operation mode is a first mode; and
executes a simple verification process when the operation mode is a second mode, in which the simple verification process includes reading out from the hierarchical expansion table the possessive layout information associated with a target cell, which is a child cell, comparing the read out possessive layout information with the verification condition, and determining whether or not the read out possessive layout information satisfies the verification condition.

11. A computer readable medium encoded with program logic for having a data verification device verify data that verifies hierarchical structure layout data for a semiconductor device, the program logic comprising:
retrieving a verification condition that is set in accordance with a data processing system which processes the layout data generated by and provided from a designing device;
extracting shaped item existing range information and possessive layout information from the layout data to generate a hierarchical expansion table and store the table in a storage unit, in which the shaped item existing range information represents a range in which a shaped item exists in cells that are included in the layout data, the possessive layout information is for referring from a cell to a cell that is at least one order lower in hierarchy, and the hierarchical expansion table associates at least either one of the shaped item existing range information and the possessive layout information with each cell;
determining a target cell and a layout path to the target cell and storing information of the determined layout path in the storage unit;
reading out the possessive layout information associated with the cell of each hierarchy forming the determined layout path from the hierarchical expansion table, cumulating the possessive layout information associated with each cell from an uppermost layer cell of the layout path to the target cell, and calculating a cumulative value of the possessive layout information for the layout path;
determining whether or not the possessive layout information satisfies the verification condition based on the cumulative value, the verification condition, and the possessive layout information; and
determining whether or not the shaped item existing range information satisfies the verification condition based on the cumulative value of the possessive layout information for the layout path, the shaped item existing range information associated with the target cell, and the verification condition.
